(19) United States
(12) Patent Application Publication
(10) Pub. No.: US 2005/0129247 A1
(43) Pub. Date: Jun. 16, 2005

(54) Device and method for generating random numbers using a pseudo random number generator

(75) Inventors: Berndt Gammel, Markt Schwaben (DE); Rainer Goettfert, Munich (DE); Holger Sedlak, Sauerlach (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 11/008,585

(22) Filed: Dec. 9, 2004

(30) Foreign Application Priority Data
Dec. 10, 2003 (DE) 103 57 782.3

(51) Int. Cl. H04L 9/00

(52) U.S. Cl. 380/286

(57) ABSTRACT

Device for generating random numbers having a pseudo random number generator, a memory and a sequential controller. The pseudo random number generator generates a deterministic random number sequence after an initialization using an initialization value. The memory stores initialization information, wherein the initialization information is derived from a true random number or corresponds to the true random number. The sequential controller initializes the pseudo random number generator at start-up using the initialization information or the information derived from the initialization information, stores an intermediate state of the pseudo random number generator or information derived from the intermediate state in the memory at a turn-off of the pseudo random number generator, and uses the intermediate state or the information derived from the intermediate state for an initialization of the pseudo random number generator at a renewed start-up.

### BACKGROUND OF THE INVENTION

### CROSS-REFERENCE TO RELATED APPLICATIONS

This application claims priority from German Patent Application No. 10357782.3, which was filed on Dec. 10, 2003, and is incorporated herein by reference in its entirety.

### FIELD OF THE INVENTION

The present invention relates to random number generators and in particular to random number generators used for cryptographic applications or other applications in which random numbers with a high quality are required.

### DESCRIPTION OF THE RELATED ART

Known random number generators, as they are for example used for chips, which are required for cryptographic purposes or other purposes in which random numbers of a high quality are required, typically comprise a physical random number generator (RNG). This physical random number generator is for example integrated in a micro-controller of a chip card. Such physical random number generators inserted onto a chip card generating so-called “true” random numbers are generally based on voltage-controlled oscillators, on thermally noisy resistors, on diodes comprising a shot noise or similar elements in which noise, i.e. a random signal, is generated in response to a physical process.

The generated random numbers are required for different security applications running within the chip card. For example, cryptographic keys are derived from the provided random numbers. Or random numbers for so-called randomizations are required in order to protect a running cryptographic algorithm against side-channel attacks this way. In addition to that, random numbers may be used for confusion purposes in the chip card. In doing so, random numbers are sent via an internal databus at irregular intervals (which are in turn derived from the random number generator) with the sole purpose of confusing a potential attacker.

A random number generator which is based on a physical random process has the following disadvantages:
1 Its setup on the silicon of the micro-controller is complicated and expensive.
2 The functioning of the physical random number generator is affected by exterior influences, like e.g. by temperature fluctuations.
3 As the physical random process is digitized in the analog RNG part (in the digital RNG part), it almost always results that the generated random bit sequence is loaded with a skew. A skew is a predomination of zeros or ones. This unbalance has to be compensated by a mathematical post-processing.
4 Often the speed with which the random numbers are generated is not high enough.

### SUMMARY OF THE INVENTION

It is an object of the present invention to provide a simpler and more practicable concept for generating random numbers.

In accordance with a first aspect, the present invention provides a device for generating random numbers, having a pseudo random number generator implemented in order to generate a deterministic random number sequence after an initialization using an initialization value; a memory for storing initialization information, wherein the initialization information is derived from a true random number or corresponds to the true random number; and a sequential controller which is implemented in order to initialize the pseudo random number generator at the start-up using the initialization information or the information derived from the initialization information, in order to store an intermediate state of the pseudo random number generator or information derived from the intermediate state in the memory at a turn-off of the pseudo random number generator, and in order to use the intermediate state or the information derived from the intermediate state for an initialization of the pseudo random number generator at a renewed start-up.

In accordance with a second aspect, the present invention provides a chip card having a device as mentioned above for generating random numbers.

In accordance with a third aspect, the present invention provides a method for generating random numbers using a pseudo random number generator which is implemented in order to generate a deterministic random number sequence based on an initialization value, a memory for storing initialization information, wherein the initialization information is derived from a true random number or corresponds to the true random number, having the steps, in a start-up of the pseudo random number generator, initializing the pseudo random number generator with the initialization information or the information derived from the initialization information; outputting random numbers of the initialized pseudo random number generator; in a turn-off of the pseudo random number generator, storing an intermediate state of the pseudo random number generator or of a value derived from the intermediate state of the pseudo random number generator into the memory; and in a renewed start-up of the pseudo random number generator, using the stored intermediate state or the information derived from the intermediate state for a renewed initialization of the pseudo random number generator.

In accordance with a fourth aspect, the present invention provides a method for manufacturing a random number generator, having the steps of providing a pseudo random number generator which is implemented in order to generate a deterministic random number sequence based on an initialization value, a memory for storing initialization information, wherein the initialization information is derived from a true random number or corresponds to the true random number, and a sequential controller, with the following steps of providing a random number; and storing the random number or the information derived from the random number in the memory as initialization information.

In accordance with a fifth aspect, the present invention provides a method for personalizing a random number generator with a pseudo random number generator, a memory and a sequential controller, wherein in the memory a true random number or information derived from the true random number is stored, having the steps of encrypting the true random number or the information derived from the true random number with personalization identification information in order to obtain an encrypted random number, storing the encrypted random number in the memory so that in a start-up of the random number generator the encrypted random number stored in the memory may be used for an initialization of the pseudo random number generator.

In accordance with a sixth aspect, the present invention provides a computer program having a program code for performing an above mentioned method.

The present invention is based on the finding that the problem of generating and providing random numbers for chip card applications may be solved by using a random number generator based on physical principles by a pseudo random number generator implemented in hardware. The used pseudo random number generator preferably meets the requirements as they are needed for cryptographic applications when it is to be used for cryptographic purposes. In addition to that it is preferred that the sequence of pseudo random numbers generated by the pseudo random number generator has such a great period length that the same is not used up in the course of a predetermined life of the chip or the chip card, respectively, or that preferably at most half of the overall period length is used up, respectively. According to the invention, this pseudo random number generator is initialized with a preferably high period length for high life times with a true random number or an initialization information derived from a true random number, respectively. According to the invention, for this the random number generator is first manufactured such that it comprises a preferably fully digital pseudo random number generator, a preferably fully digital sequencing control and a preferably non-volatile memory (NVM). In the chip factory, using a true random number generator which may in principle be complex and thus provide any good random numbers, a random number is then generated and written into the non-volatile memory of the chip.

Then the chip is shipped to the customer. Depending on the application, the customer may still encode this true random number with a highest quality before the start-up of his pseudo random number generator on the chip that the customer just received with his own personalization information if the customer wants to be sure that the initialization information which is later used for the pseudo random number generator is not completely random but also only known to himself. For applications which are not so safe, this encryption of the random number may be omitted and the customer may take the random number directly so-to-speak for the first start-up of the pseudo random number generator. The random number sequence output by the pseudo random number generator is undoubtedly a deterministic sequence of numbers which, however, preferably comprises a very high period length. As the selection of the current period provided by the pseudo random number generator is performed randomly among any possible periods generated by the pseudo random number generator based on the initialization information which is a true random number, the overall pseudo random number sequence has a random number quality meeting the highest cryptographic requirements when the individual random numbers per se are regarded. In other words, the complete sequence has a random characteristic, as the origin or seed, respectively, or the initialization information, respectively, from which the sequence is derived is a random number which so-to-speak “transmits” its random characteristics to the overall number sequence generated by the pseudo random number generator.

When the inventive random number generator is first started, by a sequential controller first the true random number or the encrypted random number is read from the memory and used for the initialization of the pseudo random number generator. The pseudo random number generator then provides a sequence of numbers with the known good characteristics which have a high and sufficient random number characteristic even for cryptographic applications due to the fact that the pseudo random number generator was initialized with a true random number.

If no random numbers are required any more, i.e. when the chip card is put out of operation, then preferably the last state of the random number generator is saved and stored in the memory of the chip either directly or encrypted. In a new start-up of the chip the pseudo random number generator is then initialized again, now, however, not with the initial random number which was preferably overwritten but with the state stored in the last turn-off. If the last state was stored encryptedly, before the initialization an decryption of the initialization value stored in the memory is required in order to initialize the pseudo random number generator so that it will “continue” at the location in the period in the repeated start-up which would have come if the pseudo random number generator had not been turned off earlier.

If the random number generator is then turned off again, then again preferably the last current state of the pseudo random number generator is used and encrypted or not encrypted depending on the implementation and then stored in the memory such that then when random numbers are required again a continuation is possible at the respective location in the period which originally goes back to the true random number.

It may be seen from this that the initialization information stored in the memory is equal to the random number in the first start-up which was stored in by the factory or was derived by encryption from the random number stored in the factory. In an intermediate operation, i.e. when the random number generator was once in operation and then taken out of operation and then put into operation again, i.e. when the pseudo random number generator is already in some place within the random number output sequence defined by the original random number, then the initialization information stored in the memory is still derived from the random number which was originally associated with the chip and stored from the factory side, as independent of any operation performed with the initialization information, the random characteristic remains. The random characteristic remains in particular when a random number is encrypted or when a random number is used in order to initialize the pseudo random number generator in order to then again at a later “point of time” in the original sequence tap a state which was derived from the original random number in a deterministic way. The present invention is advantageous in so far that now true random numbers may be generated, however without the disadvantages of a true (physical) random number generator. Thus, the inventive random number generator requires no analog elements which are complicated and expensive in the setup on the silicon of the micro-controller.

Further, the functioning of the inventive random number generator is not affected by exterior influences any more, like e.g. by temperature fluctuations etc.

Further, no analog-to-digital converters for analog-to-digital converting a naturally analog output signal of an analog physical random number generator are required so that any associated problems, like e.g. on the one hand integration and on the other hand a required mathematical post-processing, are disposed of.

Further, the present invention is advantageous in so far that the speed disadvantages of a physical random number generator do not have to be accepted as such a physical random number generator is not required any more on the chip itself. Of course, such a physical random number generator is required on the factory side. As it may, however, “seed” any number of chips, i.e. provide the same with the used random characteristic according to the invention in the form of a true random number, this physical random number generator may be of any size, any cost and implemented with any high quality in the factory without the costs of the chip manufacturing being considerably influenced by this.

Further, the inventive random number generator, as it preferably merely consists of digital elements any more, is arbitrarily scalable, i.e. may be reduced in size and thus be easily converted to any future technologies, which is of considerable importance with regard to time, which is required until a product goes from the design state to a marketable product. For the inventive concept no new circuit design is required for it to be manufactured in a new manufacturing technology which facilitates even smaller circuits. If the inventive random number generator had analog elements, however, then a new circuit design would be required as the analog elements are typically not at all down-scalable or only in a very restricted extent.

### BRIEF DESCRIPTION OF THE DRAWINGS

In the following, preferred embodiments of the present invention are explained in more detail with reference to the accompanying drawings, in which:

FIG. 1 shows a block diagram of the inventive device for generating random numbers;

FIG. 2 shows a flowchart as it is implemented by the sequential controller in a preferred embodiment of the present invention;

FIG. 3 shows a flow diagram for illustrating the inventive method for manufacturing a device for generating random numbers and for personalizing the device manufactured in a manufacturing environment for generating random numbers;

FIG. 4 shows a block diagram of an inventive pseudo random number generator according to the present invention;

FIG. 5a shows a block diagram of a pseudo random number generator according to a preferred embodiment of the present invention;

FIG. 5b shows a generalized block diagram of a pseudo random number generator according to an embodiment of the present invention;

FIG. 6 shows a preferred setup of an elementary shift register with a non-linear feedback;

FIG. 7 shows an alternative setup for an elementary shift register with a non-linear feedback;

FIG. 8 shows an alternative setup for an elementary shift register with a non-linear feedback;

FIG. 9 shows an alternative setup for an elementary shift register with a non-linear feedback characteristic;

FIG. 10 shows an exemplary setup for an elementary shift register with a non-linear feedback;

FIG. 11 shows a general illustration of an elementary shift register with memory cells in the feed-forward means and a feedback function F; and

FIG. 12 shows a known linear shift register for generating a random number sequence.

### DESCRIPTION OF THE PREFERRED EMBODIMENTS

FIG. 1 shows a device for generating random numbers according to the present invention. The device includes a pseudo random number generator (PRNG) 1000 which is implemented in order to generate a deterministic random number sequence at a random number output 1200 based on an initialization value. The pseudo random number generator 1000 is coupled to a memory 1400, wherein the memory is implemented in order to store initialization information, wherein the initialization information is derived from a true random number or is equal to the true random number. The initialization information may be equal to the initialization value with which the pseudo random number generator is initialized, or the initialization value may again for example be derived from the initialization information by a certain deterministic processing as long as the random characteristic remains in the initialization information by this processing.

Examples for such a processing are an encryption/decryption, a conversion according to a code table or according to a characteristic, in order to e.g. convert an x bit initialization information to a y bit initialization value, wherein x and y may be unequal. Preferably and in the interest of an optimum random quality, the initialization information at least with regard to the number of bits corresponds to the initialization value which the pseudo random number generator requires as a “seed”. If the pseudo random number generator for example has a shift register arrangement with x memory cells, then for initializing these x memory cells also x bits are required, wherein the initialization value for the pseudo random number generator directly corresponds to the initialization bit pattern for the memory cells, and wherein the initialization information stored within the memory preferably comprises the same number of bits as the number of registers which are present in the shift register arrangement of the pseudo random number generator.

The inventive device further includes a sequential controller 1600 which is implemented in order to load the pseudo random number generator with initialization information or information derived from the initialization information during a start-up and in order to store an intermediate state of the pseudo random number generator or a value derived from the intermediate state in the memory when the pseudo random number generator is turned off. The sequential controller 1600 is further implemented in order to retrieve the intermediate state or the value derived from the intermediate state from the memory in a new start-up and to derive a new initialization value for the pseudo random number generator from the intermediate state or the value derived from the intermediate state or to use the intermediate state itself as the new initialization value. The sequential controller 1600 is therefore implemented in order to influence both the operation of the pseudo random number generator 1000 and the operation of the memory 1400, as it is schematically illustrated by the corresponding control lines 1800 and 2000 in FIG. 1.

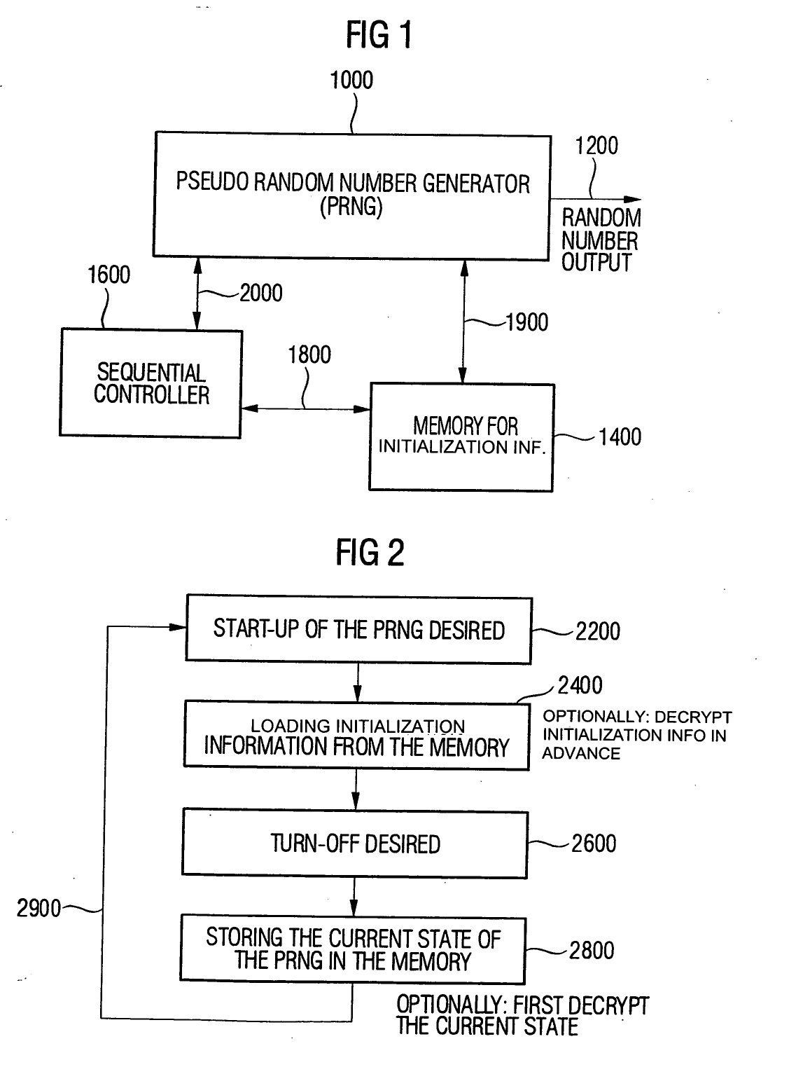

In the following, with reference to FIG. 2 the functionality of the sequential controller 1600 of FIG. 1 is addressed. In a step 2200 it is first of all determined whether the start-up of the pseudo random number generator is desired. This is the case when the sequential controller contains information that random numbers are requested. Alternatively, however, the random number generator can also be started up always when the chip is provided with energy, i.e. is regarding inserted into a terminal or is present in an electromagnetic supply field in the example of a chip card. Hereupon, the sequential controller 1600 is operable in a step 2400 in order to load the initialization information from the memory 1400 of FIG. 1 and to thus initialize the pseudo random number generator 1000 of FIG. 1, i.e. via an initialization line 1900 shown in FIG. 1. Then, when the pseudo random number generator 1000 has been initialized with the initialization information or with the information derived from the initialization information, it provides random numbers at its output 1200. This is continued until a turnoff 2600 is indicated. For this case the sequential controller 1600 is operable in order to store the current state of the pseudo random number generator in the memory in a step 2800, so that the pseudo random number generator, in a renewed start-up, as it is illustrated by a return arrow 2900, may continue at the period where it stopped.

For determining whether a turnoff is desired, different possibilities exist. One possibility is to monitor the energy supply of the chip and then, when an energy drop-off is determined, i.e. for example when the chip card is removed from the terminal or is taken out of an electromagnetic supply field, to write onto the preferably non-volatile memory 1400 with the energy stored in the capacitor for example provided for this purpose or present anyway, i.e. with the current state of the pseudo random number generator or with a state which is at least close to the current state, i.e. in general with an intermediate state of the pseudo random number generator. This may possibly cause that with a new initialization the first few numbers have no good random number characteristic. When applications are present which have no particularly high requirements, then this is not important. Even with high requirements this problematic may only be addressed by the fact that as a standard a certain number of random numbers are discarded from the initialization, i.e. are not output at the output 1200.

Alternatively, the sequential controller 1600 may be implemented, however, in order to simply store an intermediate state of the pseudo random number generator for certain predetermined unique or variable intervals, so that no energy monitoring is required. Instead, in the memory always a certain intermediate state is present then, which is in any case derived from the originally once present random number, independent of whether this was the current state directly before turning off the chip or not. In order to again guarantee the quality of the random numbers, a certain number of random numbers may easily be discarded after a renewed start-up, wherein the precise number preferably depends on the interval.

If the pseudo random number generator is operated as an alternative to a shift register consisting only of volatile memory cells with non-volatile memory cells or energy-buffered memory cells, respectively, then the memory 1400 may coincide with the pseudo random number generator 1000 in so far that the pseudo random number generator or its memory cell states, respectively, are “frozen” when the turn-off is desired in order to then, when a start-up is desired, use the initialization information which is already present in the memory to the effect that the pseudo random number generator again starts outputting further information. This means that in case of the described battery-operated or buffered pseudo random number generator, respectively, no memory separate from the random number generator is required, but that the memory 1400 is then within the pseudo random number generator, both as a memory for storing the current state and as a memory which is required in the shift register operation in order to generate random numbers at the random number output 1200.

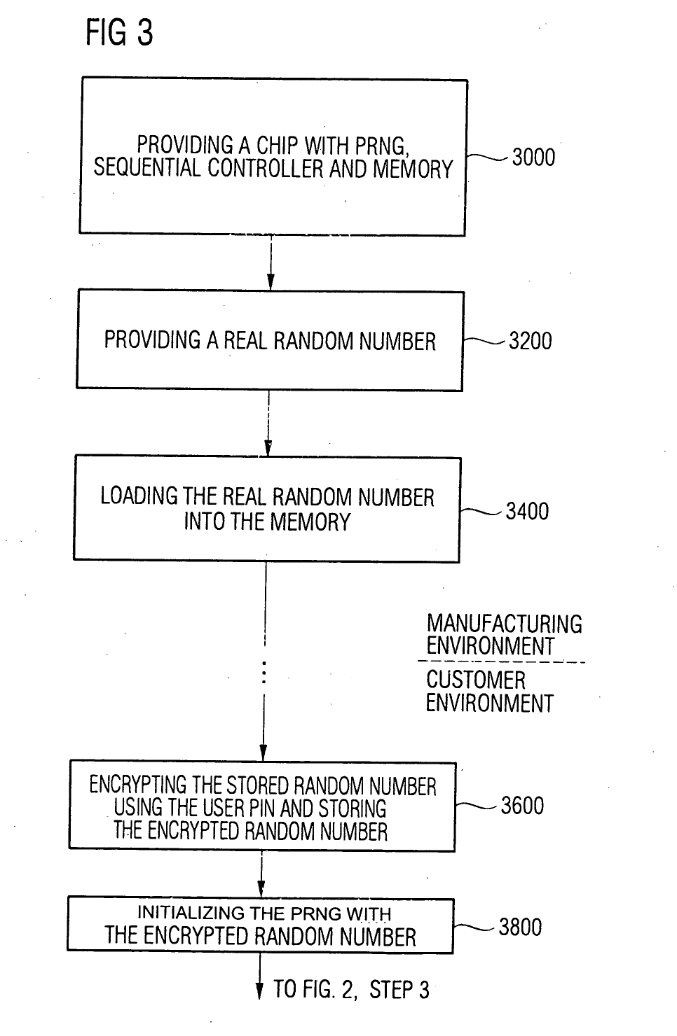

In the following, with reference to FIG. 3, a preferred method for manufacturing a random number generator according to the present invention is discussed. First of all, in a step 3000 the device shown in FIG. 1 is provided without the memory being described already, however. Then, in a step 3200, a true random number is provided, for example by an arbitrarily complex and arbitrarily good random number generator. The true random number provided in step 3200 is hereupon stored into the memory 3400 of the inventive random number generator. Then, the inventive random number generator is completed. According to the invention, the “injection of randomness” is performed in a manufacturing environment or in the factory, respectively. Then, the completed random number generator is supplied to the customer in the form of a chip. If an energy supply is not guaranteed during the supply, which will typically be the case, then the memory will be a memory separated from the random number generator, i.e. a non-volatile memory (NVM).

Depending on the security standard, the customer may now begin directly and generate random numbers, or first of all, as it is shown in FIG. 3 in a step 3600, encrypt the true random number stored in the memory using a user pin which is only known to him and store the encrypted random number, i.e. either in the external memory, if he does not directly want to generate random numbers, or directly in the random number generator, if the same is to be initialized directly and is to start with the random number generation. In the first case, the step 3600 and the step 3800 of initializing are separate from each other, while these two steps in the second case, i.e. when an initialization is directly performed after the encryption, the steps 3600 and 3800 of FIG. 3 coincide into one action.

Then, when the pseudo random number generator is initialized with the encrypted random number, the procedure described with reference to FIG. 2 continues in particular in the third step 2600 and then goes to step 2800 and via the feedback 2900 to step 2200, etc.

In the following, with reference to the further figures, a preferred implementation of the pseudo random number generator 1000 of FIG. 1 is described, which distinguishes itself through the fact that by simple means and theoretically in a predictable way high period lengths may be generated. With regard to the period length it is to be noted, that the period length becomes especially great according to the invention when as a pseudo random number generator no feedback shift register with a lineal feedback is used but a feedback shift register with a non-linear feedback, also referred to as NLFSR, wherein NLFSR stands for non-linear feedback shift register.

By preferably used pseudo random number generators, as they are described in the following, bit sequences with period lengths in the range of 2³⁰⁰ and more may be produced. Smaller pseudo random number generators, which for example include four shift registers with a non-linear feedback, wherein the first shift register comprises 31 memory cells, the second shift register e.g. 32 memory cells, the third shift register for example 33 memory cells and the fourth shift register for example 35 memory cells, require initialization information or an initialization value of 131 bits, respectively, also referred to as 131 bit seed. Thus, a random sequence with a period length of 2¹³⁰ may be generated.

As it is explained in the following, this period length is sufficient for highest cryptographic requirements. In order to illustrate this, it is to be assumed, that the chip continuously generates random bits with a speed of 1000 gigabits per second for 30 years. After 30 years then 10¹⁹ bits are used up. It is noted that 10¹⁹ is equal to 2⁶³ which is smaller than 2⁶⁵, wherein 2⁶⁵ is equal to the square root of the period length of 2¹³⁰. Thus, the “philosophy” is fulfilled, which is preferred for the random number generation, i.e. that the complete period length is never to be used up, but that approximately only the bits up to the square root of the period length should be used up. In this connection it is to be noted that the above assumption, i.e. that the chip continuously generates random bits for 30 years, i.e. with a speed of 1 gigabit per second, is an extreme requirement.

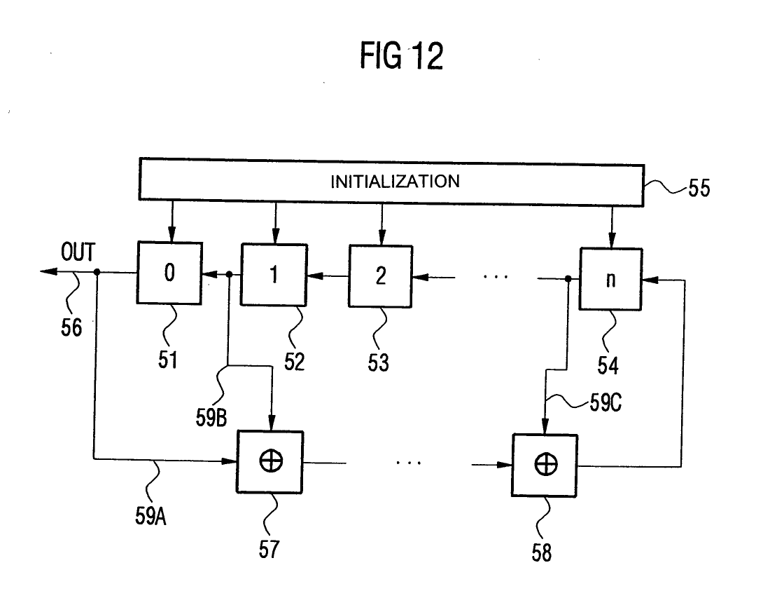

A shift register with a relatively low period length, which may, however, still be sufficient for less critical applications, is illustrated in FIG. 12. The pseudo random number generator of FIG. 12, which is also referred to as a linear feedback shift register, includes a plurality of memory elements 51, 52, 53, 54, which are numbered in FIG. 12 from 0 to n. The memory cells may be initialized to a start value via an initialization means 55. The memory cells 51-54 together form a feed-forward means, while the linear shift register formed by the memory cells 51-54 is fed back by a feedback means which is coupled between an output 56 of the circuit and the memory cell n. The feedback means includes in particular one or several combination means 57, 58, which are fed by the respective feedback branches 59a, 59b, 59c as it is illustrated as an example in FIG. 12. The initial value of the last combination means 58 is fed into the memory cell n, designated by 54 in FIG. 12.

The linear feedback shift register shown in FIG. 12 is operated by a clock, so that in every clock cycle the occupation of the memory cells is shifted to the left by one stage with reference to FIG. 12, so that in every clock cycle the state stored in the memory means 51 is output as a number, while simultaneously the value at the output of the last combination means 58 is fed into the first memory unit n of the sequence of memory units. The linear feedback shift register illustrated in FIG. 12 thus provides a sequence of numbers in response to a sequence of clock cycles. The sequence of numbers received at the output 56 depends on the start state which is produced by the initialization means 55 before the start-up of the shift register. The start value input by the initialization means 55 is then referred to as seed, which is why the arrangements illustrated in FIG. 12 are also referred to as seed generators.

The sequence of numbers obtained at the output 56 is referred to as a pseudo random sequence of numbers, as the numbers occur in a seemingly random sequence, are periodic, however, although the period cycle is long. In addition to this, the sequence of number is clearly repeatable and thus pseudo random when the initialization value which is fed into the memory element by the initialization means 55 is known.

Such shift registers illustrated in FIG. 12 have the disadvantage of a low linear complexity. Thus, in an n bit LFSR (LFSR=linear feedback shift register) 2 n bits of the output sequence are sufficient in order to calculate the complete sequence. The advantage of such known LFSRs illustrated in FIG. 12 is, however, that the hardware expense is very low. Usually, linear shift registers are described by their characteristic polynomial. The degree of the characteristic polynomial is equal to the number of delay elements of the regarded shift register, which are typically implemented as flip-flops. The exponents of the terms of f(x) except for the leading term correspond to the delay elements of the shift register which contribute to the feedback. The linear shift register illustrated in FIG. 12 would therefore have a characteristic polynomial of this kind:
f(x)=xⁿ⁺¹+xⁿ+ . . . +x+1.
If such linear shift registers, as they are illustrated as an example in FIG. 12, are loaded with an initialization state of the initialization means 55, wherein this state is also referred to as an initial state vector, then they typically output a periodic sequence which has a certain pre-period and a post-period depending on the implementation. Linear shift registers are always periodic. In technical applications it is frequently striven for the output sequence having both a great period length and also a high linear complexity.

In principle, pseudo random number generators, as they were for example illustrated with reference to FIG. 12, are required for different purposes, i.e. for simulation purposes, for performing random samples in statistics applications, for testing computer programs, in the sequential ciphering for generating a key sequence, for probabilistic algorithms, in numerical mathematics, in particular for numerical integration, for key generation in cryptology or for Monte-Carlo methods. In particular, pseudo random number generators are commercially used for security ICs, within typically integrated random number generators, within crypto-modules or for pay-TV applications or also in chip cards for mobile phones, etc.

Basically, random numbers may be generated on the basis of a physically random process or by certain mathematical manipulations. Only in the latter case are the same designated as pseudo random numbers, while in the former case true random numbers are assumed. In a pseudo random number generator, from certain initial values, the so-called seed, which is caused by the initialization means 55 of FIG. 12, numbers are generated with a typically very high speed which have to pass a whole number of tests which true random numbers would also pass. In the present invention, the seed is generated by a true physical random process in the factory or derived from the random process. As it was illustrated with reference to FIG. 12, linear feedback shift registers (LFSR) are used in order to provide pseudo random number generators. Shift registers with a linear feedback are advantageous in so far that there are mathematical theories to the effect that certain characteristics of the generated pseudo random numbers may theoretically be predicted. The most important characteristics are the period length and the linear complexity of the output sequence. Thus, theories for linear shift registers exist which allow either exact predictions of the output sequence or at least indications about the minimum length of the period and the minimum size of the linear complexity. In other words, by mathematical methods low bounds for the period lengths and the linear complexity may be indicated and proven.

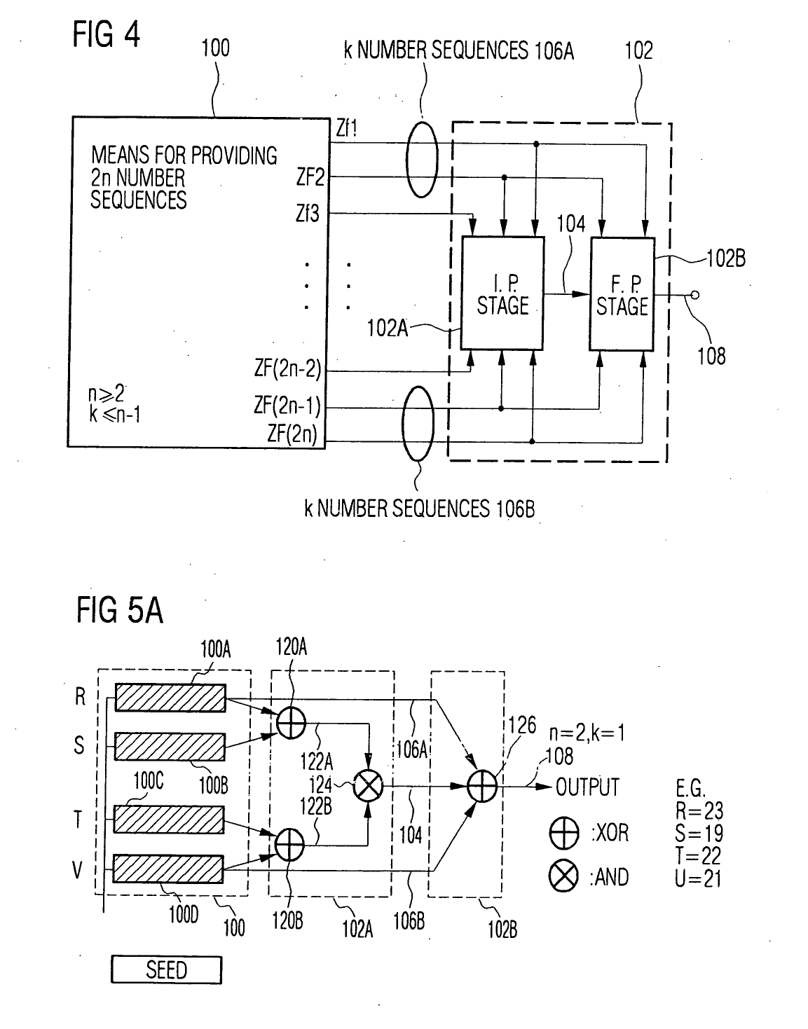

FIG. 4 shows a preferred pseudo random number generator having means 100 for providing a number of 2 n number sequences, wherein n is greater than or equal to 2. Means 100 is implemented in order to provide the number sequences of ZF1, ZF2, ZF3, . . . ZF(2n-2), ZF(2n-1) and ZF(2n). Means for providing has a downstream combination means 102 indicated in dashed lines in FIG. 4. The combination means 102 is subdivided into an intermediate processing stage 102a and 102b. The intermediate processing stage 102a is implemented in order to combine any 2 n number sequences provided by means 100 with each other in order to provide an intermediate processing sequence on an intermediate processing sequence line 104. The final processing stage 102b is then again implemented in order to combine the intermediate processing sequence on line 104 with a number of k number sequences, i.e. a subgroup with k number sequences of the original 2 n number sequences. Preferably, the final processing stage 102b is implemented in order to combine not only a first (top) subgroup of k number sequences 106a, but also a second (bottom) subgroup of k number sequences 106b with the intermediate processing sequence on line 104 in order to obtain an output sequence over time representing the pseudo random number sequence at an output 108 of the final processing stage which is at the same time the output of the pseudo random number generator.

With regard to the output sequence at the output 108, either the individual bits may be regarded as pseudo random numbers which either take the value of 0 or the value of 1. Alternatively, the output sequence may also be regarded as a pseudo random number sequence, in which a pseudo random number comprises a certain number of bits, like for example a 32-bit random number, a 64-bit random number.

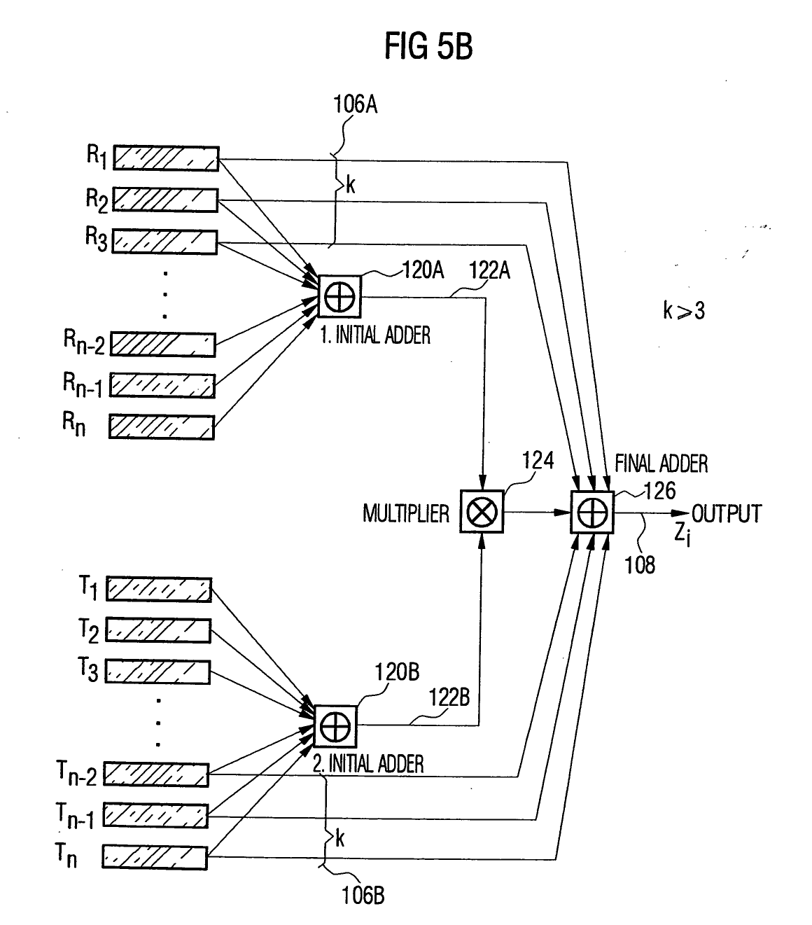

In the following, with reference to FIG. 5a, another pseudo random number generator according to a preferred embodiment is described. It is again subdivided into means 100 for providing 2 n number sequences and into the intermediate processing means 102a and the final processing means 102b. Means 100 for providing 2 n number sequences preferably includes a number of 2 n elementary shift registers with a number of memory cells, wherein the number of memory cells is respectively designated by R, S, T or U, respectively, in addition to the corresponding elementary shift register, like for example 100a, 100b, 100c and 100d. The individual elementary shift registers 100a-100d which all preferably comprise a non-linear feedback characteristic, are coupled to an initialization means 110 which is implemented in order to provide a “seed” in order to put the individual elementary shift registers 100a-100d into a defined initial state so that based on this initial state they respectively generate a reproducible defined pseudo random number sequence. It is to be noted that all non-linear shift registers 100a-100d may be initialized to the same value or to different values. Typically, the elementary shift registers comprise different numbers of memory cells, however, so that they are typically initialized to different values.

FIG. 5a so-to-speak shows a minimal version, as means 100 only includes four elementary shift registers 100a, 100d, such that the parameter n is equal to 2. Due to the definition of the parameter k, which indicates the number of number sequences which are not only provided to the intermediate processing stage but also to the final processing stage, this parameter may only take the value of “1” in the embodiment shown in FIG. 5a, such that the top subgroup of k number sequences designated by 106a in FIG. 5a only includes one single number sequence and that the bottom subgroup of number sequences, designated by 106b in FIG. 5a, also only includes one single number sequence provided by means 100.

In the embodiment shown in FIG. 5a, the intermediate processing means is implemented in order to include a first initial adder 120a and a second initial adder 120b in order to first obtain a first sub-processing result at a top adder output line 122a and a corresponding second sub-processing result at a bottom adder output line 122b. The signals on lines 122a and 122b are finally multiplied with each other in a multiplier 124 in order to output the intermediate processing sequence on line 104. The intermediate processing sequence is then fed to the final processing stage 102b which only includes one single adder 126 in order to add up the intermediate processing sequence on line 104 with the first subgroup 106a of k number sequences and the second subgroup 106b with k number sequences in order to obtain the output sequence.

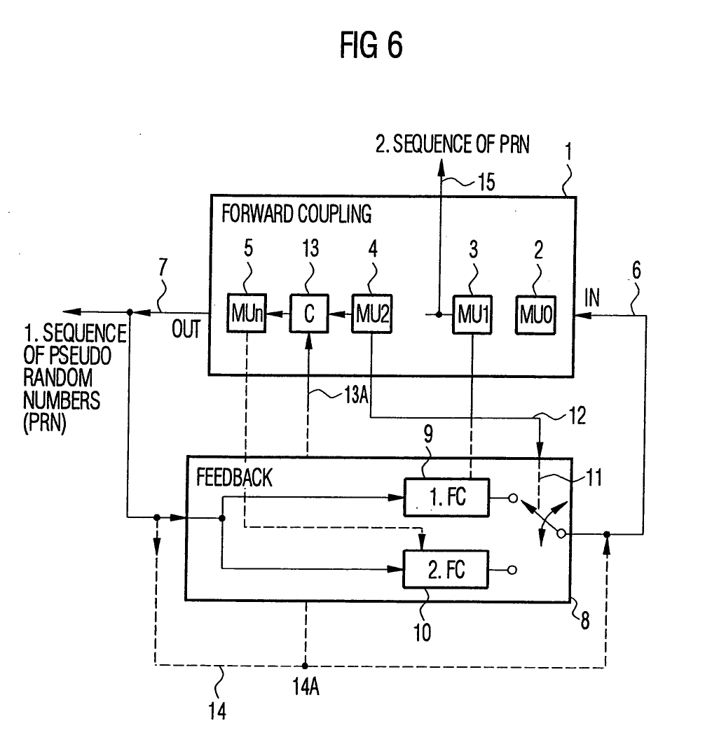

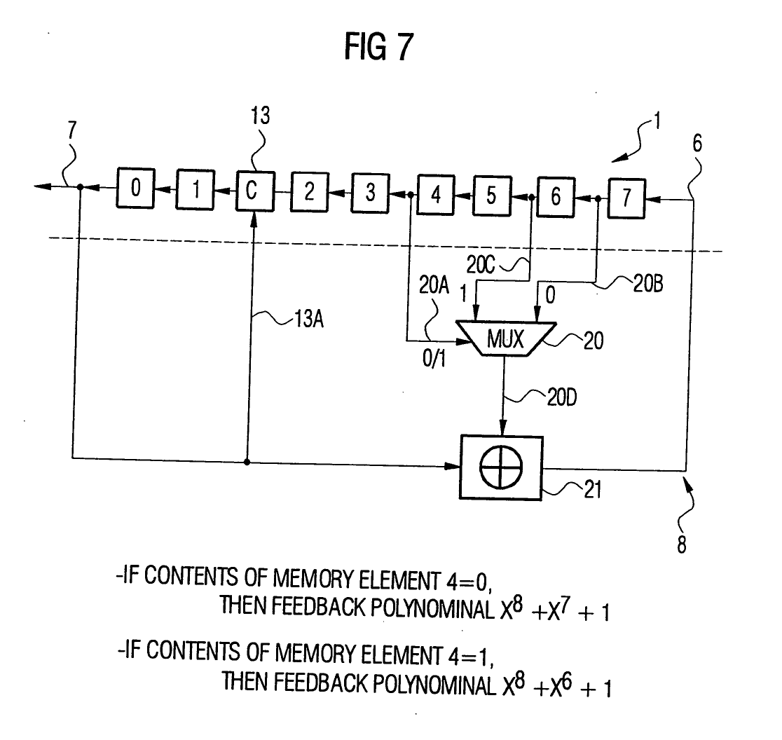

In particular, the shift register 100a consists of R memory cells. The shift register 100b consists of S memory cells. The shift register 100c consists of T memory cells and the shift register 100d includes U memory cells. In principle, the shift registers are set up such as it is illustrated in the following with reference to FIG. 4 or to FIGS. 6 and 7.

In one preferred embodiment, the shift registers are set up such that the numbers R, S, T and U are prime in pairs. In one preferred embodiment the values R=23, S=19, T=22 and U=21 are selected. Thus, due to the connections which are explained in more detail below, for the period length of the key sequence an approximate value results as follows:
period length≈2⁸⁵.

For the linear complexity of the key sequence an approximate value results which, based on the connections which are later explained in more detail, is as follows:
linear complexity≈2⁴⁵.

In another application example R=31, S=29, T=30 and U=22 may hold true. In this case, for the period length the following approximate value results:
period length≈2¹¹⁵.

For the linear complexity the following value results:
linear complexity≈2⁶¹.

In the following, the preferred characteristics of the pseudo random number generator illustrated in FIG. 5a are again illustrated clearly. In particular, the preconditions are indicated in order to obtain a maximum predictability and also a maximum periodicity, maximum linear complexity, best correlation immunity and best avalanche criterion results:

NLFSR#1 has R memory cells

NLFSR#2 has S memory cells

NLFSR#3 has T memory cells

NLFSR#4 has U memory cells
For the numbers R, S, T and U the following has to hold true

ggT(R,S)=ggT(R,T)=ggt(R,U)=ggt(S,T)=ggt(S,U)=ggt(T,U)=1.

(rᵢ)=(r₀,r₁,r₂, . . . ) is the output sequence of NLFSR#1,

(sᵢ)=(s₀,s₁,s₂, . . . ) is the output sequence of NLFSR#2,

(tᵢ)=(t₀,t₁,t₂, . . . ) is the output sequence of NLFSR#3,

(uᵢ)=(u₀,u₁,u₂, . . . ) is the output sequence of NLFSR#4.

All the shift registers are maximum periodic and so that they generate output sequences of a maximum linear complexity. The following holds true:

per((rᵢ))=2^{R}−1 and lin. compl. ((rᵢ))=2^{R}−2,

per((sᵢ))=2^{S}−1 and lin. compl. ((sᵢ))=2^{S}−2,

per((tᵢ))=2^{T}−1 and lin. compl. ((tᵢ))=2^{T}−2,

per((uᵢ))=2^{U}−1 and lin. compl. ((uᵢ))=2^{U}−2.

Characteristics of the key sequence (zᵢ):
maximum period length:
   per((zᵢ))=(2^{R}−1)(2^{S}−1)(2^{T}−1)(2^{U}−1)
high linear complexity
   lin. compl. ((zᵢ))=(2^{R}−2)(2^{T}−2)+(2^{R}−2)(2^{U}−1)+(2^{S}−1)(2^{T}−2)+(2^{S}−2)(2^{U}−2)+2^{R}+2^{U}−4
correlation immunity

$$P ( {r}_{i} = {z}_{i} ) = P ( {s}_{i} = {z}_{i} ) = P ( {t}_{i} = {z}_{i} ) = P ( {u}_{i} = {z}_{i} ) = \frac{1}{2}$$

FIG. 5b shows a generalized version of the pseudo random number generator of FIG. 5a. In particular, the balance preferred according to the invention may be seen in so far that first of all 2 n number sequences are provided and that the first n number sequences, i.e. the outputs of the first n shift registers R₁, R₂, R₃, . . . , Rₙ are in principle treated the same as the second (lower) n output signals of the corresponding elementary shift registers T₁, T₂, T₃, Tₙ. The combination means with the intermediate processing stage on the one hand and the final processing stage on the other hand is again set up as illustrated in FIG. 5a. As a difference to FIG. 5a, however, the individual adders 120a, 120b and 126 have a greater number of inputs than in the first case, as also the number of the number sequences compared to the case of FIG. 5a is now arbitrarily high. Further, in FIG. 5b the case is illustrated in which the number is k=3 (or higher).

The general device in FIG. 5b thus consists of 2×n maximum-periodic NLFSRs. The number of memory cells of the 2 n NLFSRs is preferably prime in pairs. Further, the device contains two initial adders 120a, 120b, a multiplier 124 and a final adder 126. It is to be noted that the addition and multiplication in the binary case are “modulo 2”, i.e. that the addition is equal to the XOR operation. In addition to that, the multiplication is also regarded as a modulo multiplication in the binary case and thus corresponds to an AND operation.

The combination means is implemented in order to feed the output sequences of the first n shift registers to the first initial adder and to feed the output sequences of the second n shift registers to the second initial adder. The output sequences of the two initial adders are fed to the multiplier. The output sequence of the multiplier is finally fed to the final adder. Further, the number k is selected in order to be between 1 and n−1. Now, k NLFSRs are selected from the group of the first n NLFSRs. Further, also k NLFSRs are selected from the second group of NLFSRs. The output sequences of any selected 2 k shift registers are directly fed into the final adder, as it may in particular be seen from FIGS. 4 to 5b. In the following, for the case shown in FIG. 5b a number of preferred settings for the shift registers and the combination means is presented in order to obtain an optimum pseudo random number generator comprising the corresponding above-mentioned characteristics in an optimum way.

R₁, R₂, . . . , T₁, T₂, . . . are the numbers of memory cells of the occurring NLFSRs.

The preferred precondition of the prime characteristic is:

ggT(Rᵢ,Rⱼ)=1, ggT(Tᵢ,Tⱼ)=1 for i≠j

and ggT(Rᵢ,Tⱼ)=1 for any i, j ε {1, 2, . . . , n}.

The sizes of any shift registers is therefore numbers, taken in pairs, that do not have a common divisor.

Any occurring shift registers are non-linear and maximum-periodic. E.g. the first shift register consists of R₁ memory cells and produces a bit sequence of the period length 2^{R1}−1.

The number k fulfils 1≦k≦n−1.

The output sequence (Zᵢ), i=1, 2, 3, . . . of the complete device has the following characteristics:
1. (Zᵢ) is correlation immune with regard to the output sequence of any individual shift register
2. (Zᵢ) fulfils the strict avalanche criterion
3. The period length of (zᵢ) is

$$period = {\prod }_{i = 1}^{n} ( {2}^{{R}_{i}} - 1 ) {\prod }_{i = 1}^{n} ( {2}^{{T}_{i}} - 1 )$$

The linear complexity L of (Zᵢ) is

$$L = ( - 2 n + {\sum }_{i = 1}^{n} {2}^{{R}_{i}} ) ( - 2 n + {\sum }_{i = 1}^{n} {2}^{{T}_{i}} ) + {\sum }_{i = 1}^{k} ( {2}^{{R}_{i}} + {2}^{{T}_{i}} ) - 4 k$$

The above-described pseudo random number generators are in particular suitable for sequential ciphering. Preferably, the pseudo random number generators illustrated in FIGS. 4 to 5b are implemented as simple hardware devices in order to be used in a stream cipher.

In the following, with reference to FIGS. 6 to 10, a number of different embodiments for implementing the individual elementary shift registers is given. It is to be noted, that not necessarily any shift registers have to have the same setup, but that they may have different setups, as long as at least one and preferably all shift registers have a non-linear feedback characteristic.

FIG. 6 shows an elementary shift register with a non-linear feedback for generating a pseudo random sequence of numbers with a feed-forward means 1 comprising a sequence of memory units 2 to 5 and further including an input 6 and an output 7 corresponding to the output of the device for outputting the sequence of pseudo random numbers. It is to be noted, that the sequence of pseudo random numbers may be supplemented by further means which are not shown in FIG. 6 in order to buffer sequences of random numbers, combine the same in any other way, etc.

The device shown in FIG. 6 further includes a feedback means 8 comprising a variable feedback characteristic and connected between the input 6 and the output 7 of the feed-forward means 1. The variable feedback characteristic of the feedback means 8 is illustrated in FIG. 6 in so far that the feedback means 8 may accept a first feedback characteristic 9 or a second feedback characteristic 10, wherein between the first feedback characteristic 9 and the second feedback characteristic 10 for example a toggling may be performed by a toggle means 11. The control signal for the toggle means 11 is provided merely exemplarily from the fourth memory means SE2, as it is symbolically illustrated by a signal path 12. The first feedback characteristic 9 and the second feedback characteristic 10 are different in an embodiment shown in FIG. 6 in so far that in case of the first feedback means the state of the memory means 1 (No. 3) is introduced into the feedback, while in case of the second feedback means the state of the memory means 5 (SEn) contributes to the feedback.

Alternatively or additionally, the feedback means 8 may be implemented such that in the feedback characteristic combining the value at the output 7 of the feed-forward means to an interior state of the feed-forward means, depending on the selected feedback characteristic, another combination specification is used. Thus, for example in the first feedback characteristic for a combination of the value at the output 7 to the value at the register cell 3 an AND may be used, while the second feedback characteristic is different from the first feedback characteristic in so far that for a combination of the two mentioned values not an AND but an OR is used. It is obvious for persons skilled in the art that different types of different combination specifications may be used.

In addition to that, values of the memory means SE1 or SEn, respectively, do not directly have to be fed to a combination means in the feedback means, but those values may for example be inverted, combined with each other or be processed e. g. in a non-linear way in any other way, before the processed values are fed to a combination means.

In addition, it is not essential that the toggle means 11 is directly controlled by the state of the memory unit SE2. Instead, the state of the memory means SE2 may be inverted, be processed logically or arithmetically in any other way or even be combined with the state of one or several further memory means as long as one device for generating a pseudo random sequence of numbers is obtained comprising a feedback means whose feedback characteristic is not static but dynamically dependent on the feed-forward means and in particular variable from one or several states in the memory units of the feed-forward means.

In the feed-forward means 1 of FIG. 6 further a control means 13 is introduced, arranged between two memory elements, i.e. the memory elements 4 and 5 in the example shown in FIG. 6. After a signal flow from the memory element 0 to the memory element n in FIG. 6 takes place, the memory element 4 is the memory element arranged before the control means with regard to the signal flow, while the memory element 5 is the signal arranged after the control means with regard to the signal flow. The control means 13 has a control input 13a which may be imparted with a control signal which may in principle be any control signal.

The control signal may for example be a true random number sequence, so that the output sequence of the shift register arrangement is a random number sequence. The control signal may also be a deterministic control signal, so that on the output side a pseudo random number sequence is obtained.

Preferably, the control input 13a is connected to the feedback means 8, however, as it is illustrated by the corresponding dashed line in FIG. 6, such that a signal in the feedback means provides the control signal for the control means 13, i.e. the control signal is a deterministic signal.

Although in the embodiment shown in FIG. 6 the feedback means 8 is referred to as a variable feedback means in the embodiment shown in FIG. 6, the feedback means may also be a feedback means with a constant feedback characteristic, as it is indicated by a dashed line 14. In this case the control signal for the control input 13a would be derived from a branching point 14a, as it is schematically illustrated in FIG. 6, i.e. by the dashed line from point 14a to the control input 13a of the control means 13.

Further, in order to increase the efficiency, the elementary number sequence generator shown in FIG. 6 is used in order to for example not only generate a sequence at the output 7 but in order to generate a second sequence of preferably pseudo random numbers at a further output 15, wherein both sequences or only one sequence of the two sequences may be fed into the combination means. The insertion of the control means 13 causes the sequence output at the output 7 to be indeed different from the sequence output at the output 15, wherein the two sequences are not shifted with respected to each other but are indeed different, as it has been described, as they are “tapped” before or after the control means 13, respectively, with regard to the signal flow.

FIG. 7 shows an 8-bit shift register, wherein depending on the state of the memory means having the number 4 a multiplexer 20 is controlled via a control input 20a. If the control input 20a is on a zero state, i.e. if in the memory cell with the number 4 a zero state is present, then the multiplexer is controlled such that it connects the state of the memory means with the number 7 at a first input line 20b of the same to an output line 20d. This would correspond to the effect of a linear shift register with the following feedback polynomial:
x⁸+x⁷+1

If the control input 20a is on a one state, however, then the state of the memory means with the number 6 at a second input 20c is connected to the output line 20d of the multiplexer 20. The output line 20d is connected to a combination means 21 which in the embodiment shown in FIG. 7 is further fed with the value at the output 7 of the feed-forward means which simultaneously forms the output of the device for generating a pseudo random sequence of numbers. The result which is calculated by the combination means 21 is again fed to the first memory means having the number 7 in FIG. 7.

If therefore the content of the memory cell having the number 4 is equal to 1, then the following feedback polynomial is present:
x⁸+x⁶+1

From the above it may be seen that between the two mentioned feedback polynomials a toggling is performed, i.e. depending on the content of the memory cell having the number 4 of the feed-forward means 1.

It may be seen that the linear complexities of sequences obtained according to the invention are high, i.e. between 234 and 254, when the shift register has 8 flip-flops. It is to be noted that the period length of one sequence which is generated by any eight-stage shift register may at maximum be 255. The maximum value for the linear complexity of such a sequence is 254.

The simplest of all eight-stage elementary shift registers that may generate a sequence is the shift register illustrated in FIG. 7 with the two feedback polynomials illustrated in FIG. 7. With regard to the theory of the linear shift registers as a comparative example it is to be noted that there are 16 primitive polynomials of the 8^{th} degree. Every such polynomial describes a linear shift register that may generate a sequence of the period length of 255 and the linear complexity of 8. Compared with this many more shift registers exist—i.e. 2020—according to the present invention, which may generate sequences of the period length of 255 according to the present invention.

In addition to this, the sequences generated by the inventive shift registers have much higher linear complexities than their analog implementations according to the prior art. As it has been discussed, among all examined possibilities for an 8-bit shift register with a feedback means, the implementation shown in FIG. 7 is preferred, as it has the simplest hardware expense, at the same time a maximum period length and further comprises a maximum linear complexity.

In FIG. 7 further again a control means 13 is arranged between two memory elements, wherein these are the memory elements 1 and 2. The control means 13 is provided with a control signal tapped from the feedback means 8 with a variable feedback characteristic. Of course, the signal for the control means may also be “tapped” downstream of the XOR gate 21 with reference to the signal flow. In addition to that, the control means 13 may of course also be implemented between any other two memory cells, like e.g. between the memory cells 5 and 6 or between the memory cells 0 and 7, i.e. either in signal flow direction after the memory cell 0 so that the signal at the output of the memory means is directly output at the output 7, or directly before the memory cell 7.

For signal processing reasons it is preferred, however, that all signals, like e.g. output sequences, control signals and data signals for the multiplexer etc. are tapped at the output of shift registers, so that the shift register, apart from its functionality for generating the number sequence, also serves for providing stable signals for logic gates. Thus, no corresponding output stages for logic gates have to be generated, when control signals or output signals are directly tapped from the outputs of the logic gates themselves.

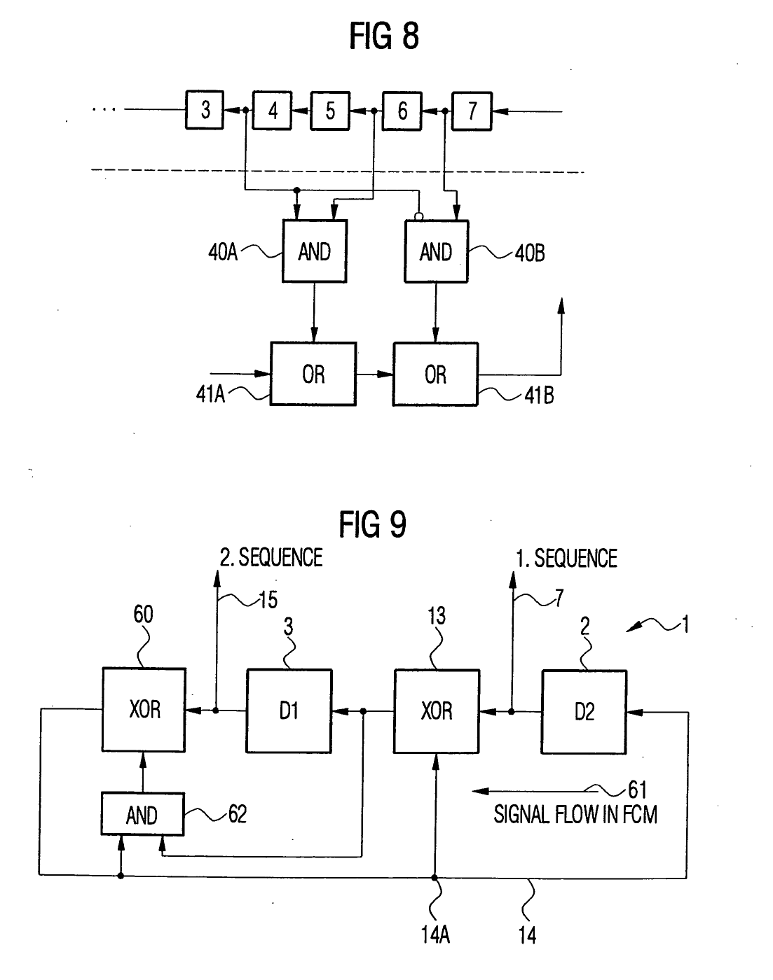

In the following, reference is made to FIG. 8 in order to illustrate a special implementation of the multiplexer means 20 of FIG. 7. The multiplexer 20 may easily be implemented by two AND gates 40a, 40b which are both connected to serially switched OR gates (or XOR gates) 41a, 41b, as it is shown in FIG. 8. In particular, the state of the memory cell 4 is fed to the first AND gate 40a, while the inverted state of the memory cell 4 is fed to the second AND gate 40b. For determining the corresponding feedback polynomial, the content of the memory cell 6 is fed to the first AND gate 40a as a second input, while the content of the memory cell 7 is fed to the second AND gate 40b as the second input. Further, it is to be noted, that the two series-connected OR gates 41a, 41b may be implemented alternatively. If, however, implementations are required in which any logic gate has two inputs and one output, the exemplary illustration shown in FIG. 8 is advantageous.

In a method for generating a pseudo random sequence of numbers from an elementary shift register using a feed-forward means 1 with a plurality of memory means comprising an input and an output for outputting the sequence of numbers and a feedback means comprising a variable feedback characteristic and connected between the input and the output, first of all a step of initializing the memory means in the feed-forward means to a certain initial value is performed.

In response to a state of a memory means of the plurality of memory means of the feed-forward means, then in a further step the control means is controlled depending on the feedback signal. Hereupon, a state of a memory means connected to the output of the feed-forward means 1 is output in order to obtain a number of the sequence of random numbers. Hereupon, it is examined in a decision block whether further random numbers are required. If this question is answered by no, the method is ended. If it is determined, however, that further numbers are required, then the decision block is answered by “yes”, whereupon a further step follows in which the plurality of memory means is newly occupied based on a preceding state of the memory means and on an output of the feedback means. In a loop, the steps of controlling the control means, outputting and occupying are repeated any number of times in order to finally obtain the pseudo random sequence of numbers.

It is to be noted that this method may be performed using a regular clock or also using an irregular clock, although the variant comprising a regular clock is preferred with regard to a better security against power or time attacks.

In case of the linear shift register illustrated in FIG. 7 it is to be noted that the reoccupation of the plurality of memory means is performed serially, i.e. based on the preceding state of the memory means which is shifted by one step to the left—altogether—so that on the output side a state of the memory means 0 “falls out”. This “fallen-out” value is the number that is output. By the left-shift of the state regarded in total of the complete memory means, the memory means on the far right with the number 7 in FIG. 7 may be occupied new. The plurality of memory means and in particular the memory means 7 is therefore newly occupied depending on an output of the feedback means at the current clock time.

FIG. 9 shows an alternative embodiment in which the alternative of the feedback means is illustrated designated by the reference numeral 14 in FIG. 6. In particular, the feedback means 14 in FIG. 9 is implemented such that it has no variable feedback characteristic but a constant feedback characteristic. The inventive advantages are achieved by the fact that at least one control means 13 and preferably a further control means 60 are arranged in the feed-forward means.

In the embodiment shown in FIG. 9, the control means 13 is controlled with a control signal which is directly derived from the feedback means 14. In the feed-forward means shown in FIG. 9, only two memory means 2 and 3 are provided, wherein the first control means 13 is connected between the memory cell 2 and 3 while the second control means 60 is connected between the memory cell 3 and (via the feedback means 14) the memory cell 2. Further, in FIG. 9 a signal flow is marked by an arrow 61 illustrating the signal flow in the feed-forward means extending from left to right in the embodiment shown in FIG. 9. One bit first of all enters the memory means D2. Thus, the bit stored in D2 is output and forms one bit of the first sequence. Simultaneously, the bit output by the memory means 2 is XORed with a bit currently applied to the feedback means 14 in the embodiment shown in FIG. 9, in order to obtain a result bit at an output of the XOR operation which is then clocked into the memory element 3 in the next cycle. Thus, the bit currently present in the memory element 3 is clocked out of the memory element 3 and thus represents a bit of the second pseudo random sequence of numbers. The bit at the output of the memory cell 3 is then XORed with a control signal for the second control means 60, wherein the control signal is generated from the signal at the feedback means 14 and the output signal of the first control means 13 by means of a combination means. The combination means 62 is preferably a logical gate and in particular an AND gate in the embodiment shown in FIG. 9. The first sequence is output via an output 7, while the second sequence is output via an output 15. The two sequences output via the outputs 7 and 15 are actually different and not only phase-shifted to each other.

In order to simplify the implementation of the XOR gate 60, in another preferred embodiment in the signal flow direction after the XOR gate 60 a further memory element is provided, wherein then, at the output of this memory element, a sequence is output which is only phase-shifted to the first sequence at the output 7, which is, however, fundamentally different to the second sequence at the output 15.

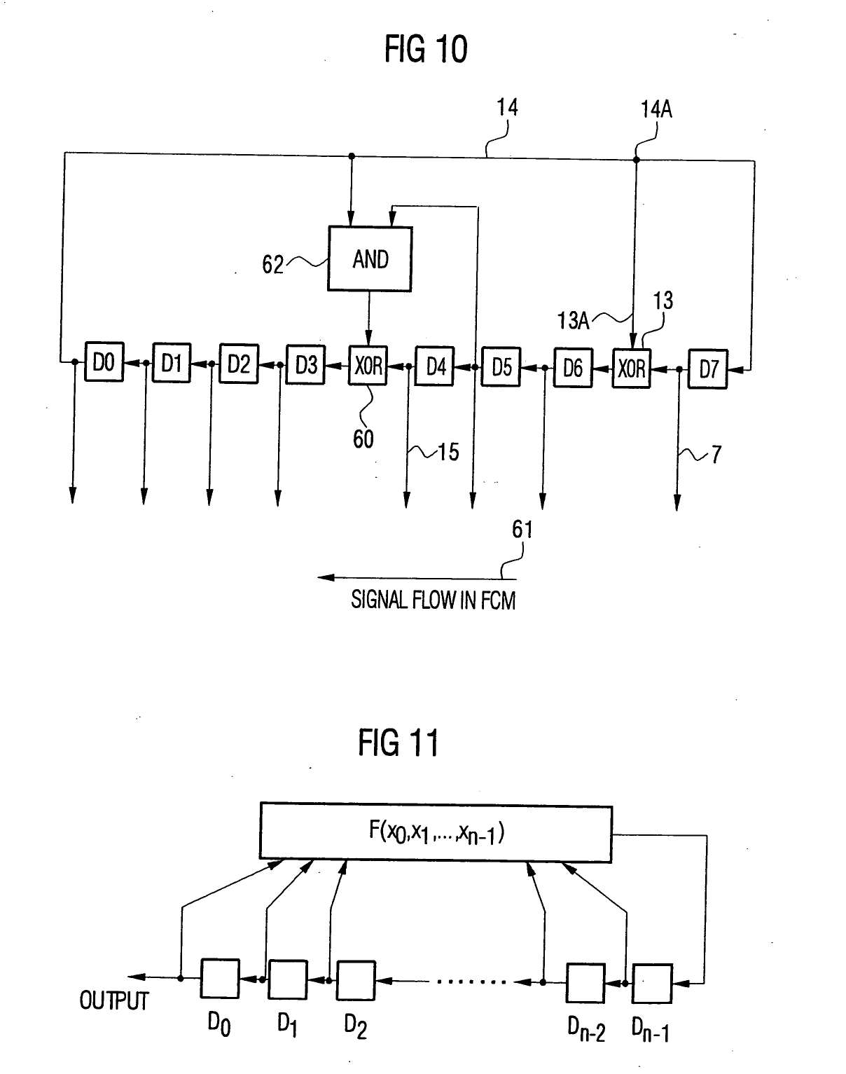

FIG. 10 shows an 8-bit elementary shift register with flip-flops D0-D7 which are serially connected to each other, wherein further between the fourth and the third flip-flop the second control means 60 is provided, while between the seventh and the sixth flip-flop the first control means 13 is provided. The first control means 13 is again directly provided with the feedback signal on the feedback means 14, while the second control means 60 is provided with the output signal of the AND gate 62 which is again provided by the feedback means 14 on the one hand and the output signal of the fifth cell D5 on the other hand. Analogous to the embodiment shown in FIG. 9, the output sequence of the fourth cell D4 represents the second pseudo random number sequence, while the output sequence of the seventh cell D7 represents the first random number sequence.

The embodiments shown in FIGS. 9 and 10 for an elementary shift register are different in so far that between the two control means two further register cells D5, D6 are connected, and that at the output of the XOR control means 60 further memory cells D0-D3 are implemented, so that an 8-bit shift register results. In one embodiment, in order to obtain an especially efficient pseudo random number generator, at the output of every memory cell D0-D7 a pseudo random number sequence is tapped and fed to a combination means. In particular, the two sequences output by the cells D4 and D5 are shifted versions of the sequence output by the cell D6. Further, the four sequences output by the cells D2, D1, D0 and D7 are shifted versions of the sequence output by the cell D3. Thus, every sequence of the cells D7, D0, D1, D2, D3 is essentially different to a sequence of the cells D4, D5, D6.

It is to be noted, that the initial state by which the shift register is initialized is to be implemented as the so-called seed which was explained with reference to FIG. 7, element 55 in so far that it includes at least a value for a memory element which is unequal to zero, so that the shift register so-to-speak “starts up” and does not output eight zero sequences at the eight outputs. Then, when this condition is fulfilled, all eight sequences are maximum-periodic, i.e. have a period length of 255. Further, each of the eight output sequences in the embodiment shown in FIG. 10 comprises the maximum linear complexity 254. In addition to that, as it has been explained, the two sequences output by the cells D3 and D6 are fundamentally different.

As it may further be seen from FIG. 10, here, the memory cell D5 is the control cell. When the cell D5 contains a zero, then the effect of the control means 60 between the cells D3 and D4 is suppressed. Only the XOR between the cells D6 and D7 is applied then. If the cell D5 includes a 1, however, both XOR means 13 and 60 are applied.

FIG. 11 shows a general feedback shift register comprising memory cells D₀, . . . , Dₙ₋₁ having a feed-forward means and a feedback means, designated by F(x₀, x₁, . . . , xₙ₋₁).

A general n-stage (or n-cell) feedback shift register above the basic member GF(2)={0,1} is regarded. The shift register consists of n memory cells (flip-flops) D₀, D_{1,} . . . , Dₙ₋₁, and the (electronic) realization of a feedback function F(x₀, x₁, . . . , xₙ₋₁). The feedback function associates a unique value from GF(2), i.e. the value 0 or 1, to every n-tuple consisting of n bits. In mathematical terminology F is a function with a definition range GF(2)ⁿ and a target range GF(2).

The shift register is controlled by an exterior clock. With every clock rate the content of the memory cell Dⱼ is shifted into the left neighboring cell Dⱼ₋₁. 1≦j≦n−1. The content of the memory cell D₀ is output. The contents of the memory cells D₀, D₁, . . . Dₙ₋₂, Dₙ₋₁ at the time t are given by
sₜ, sₜ₊₁, . . . , sₜ₊ₙ₋₂, sₜ₊ₙ₋₁.

Then the memory cells contain the following bits one clock rate later, i.e. at the time t+1
sₜ₊₁, sₜ₊₂, . . . , sₜ₊ₙ₋₁, sₜ₊ₙ,
wherein the value sₜ₊₁ introduced into the cell Dₙ₋₁ is given by
sₜ₊ₙ=F(sₜ, sₜ₊₁, . . . , sₜ₊ₙ₋₁).

The n-tuple (sₜ, sₜ₊₁, . . . , sₜ₊ₙ₋₁) describes the state of the shift register at the time t. The n-tuple (s₀, s₁, . . . , sₙ₋₁) is called the initial state. As a short version for the general feedback shift register having a feedback function F, FSR(F) is used (FSR stands for feedback shift register). FIG. 12 shows a general feedback shift register.

With every rate of the exterior clock the shift register outputs one bit. This way, the shift register may produce a periodic bit sequence s₀, s₁, s₂, . . . , a so-called shift register sequence. s₀, s₁, . . . , sₙ₋₁ be the initial values of the shift register sequence. The feedback function F(x₀, x₁, . . . , xₙ₋₁) and the initial values s₀, s₁, . . . , sₙ₋₁ completely determine the shift register sequence. As there are only 2ⁿ different states for the shift register, the period length of the shift register sequence s₀, s₁, s₂, . . . is at maximum 2ⁿ.

A general feedback shift register FSR (F) is called homogenous when its feedback function F is homogenous, i.e. when F(0, 0, . . . , 0)=0 holds true. A homogenous shift register set into the initial state s₀, s₁,= . . . =sₙ₋₁=0

produces the zero sequence. One may conclude from this that the period length of the output sequence of an n-stage homogenous shift register may be at most 2ⁿ−1. When the period length takes the maximum value of 2ⁿ−1, then the shift register sequence is called an M sequence and the shift register is called maximum. It is an important aim to find maximum shift registers.

Two special cases of the general feedback shift register FSR(F) are of special interest. The case in which the feedback function F has the form of

$$F ( {x}_{0} , {x}_{1} , … , {x}_{n - 1} ) = {\sum }_{0 \leq i \leq j \leq n - 1} {a}_{i j} {x}_{i} {x}_{j}$$

wherein the coefficients aᵢⱼ are either 0 or 1. In this case a quadratic feedback function is mentioned as an example for a non-linear feedback function and the designation quadratic is also transferred to the shift register.

The other special case is present when the feedback function F is linear. F then has the form of
F(x₀, x₁, . . . , xₙ₋₁)=a₀x₀+a₁x₁+ . . . +aₙ₋₁xₙ₋₁,
wherein the occurring coefficients aᵢ are again equal to 0 or 1, i.e. elements from GF(2). In this case, a linear or linear feedback shift register is regarded and the short version LFSR is used for the same (linear feedback shift register). It is to be noted that both the linear feedback and also the quadratic feedback shift registers are homogenous.

An n-stage linear feedback shift register is usually characterized by a binary polyniomial f(x) of the degree n in a variable x. This polynomial f is called the characteristic polynomial of the linear feedback shift register. For the shift register the writing LFSR(f) is used.

The feedback function F(x₀, x₁, . . . , xₙ₋₁) of a linear feedback shift register is a polynomial in n variables x₀, x₁, . . . , xₙ₋₁ and of the degree 1. In contrast to this, the characteristic polynomial f(x) of the same linear shift register is a polynomial of only one variable, i.e. the variable x but of the degree of n. The following holds true
F(x)=xⁿ+F(1, x, x², . . . , xⁿ⁻¹).

The non-linearity of the feedback function may therefore be performed by relatively arbitrary implementations of the feedback function F. For this, it will in principle suffice to only multiply the output signals of two memory cells Dᵢ and Dᵢ₊₁ with each other, whereby a quadratic shift register would result. Of course, also more than two memory cell outputs may be multiplied with each other or be subjected to some non-linear function. In principle, however, also a feedback with only one output signal of one single memory cell may be performed by only for example performing a feedback of the output signal of the memory cell D₀ into which the function F(x₀) is fed and the output signal of this function is for example fed into the input side of the memory cell Dₙ₋₁. Such a non-linear function with only one single value would for example be an inversion, i.e. a logical NOT function. The non-linear function may, however, also be any other function, for example a non-linear assignment function or a cryptographic function.

In the present invention, a pseudo random number generator, depending on a freely selectable seed, produces a bit sequence in a deterministic way which meets any known criteria of a true random sequence. The seed is a bit sequence which is some hundred bits long. The feeding of a seed into the pseudo random number generator is referred to as the initialization of the pseudo random number generator.

Certifiers request that random numbers used for cryptographic purposes are true random numbers in the sense that they are derived from a physical random process and are not reproducible. These requirements are fulfilled in the following way: In the production of the chip in the factory in a special machine on the basis of a physical random process a random bit sequence is generated. This bit sequence is at least one hundred bits long. The bit sequence is now written as a seed into the NVM (non volatile memory, e.g.: EEPROM) of the chip. This process is called “personalizing”. With the help of the pseudo random number generator present on the chip, then depending on the seed a bit sequence is generated which may not be differentiated from a true random sequence.

This preferably very long bit sequence now provides any random numbers required during the lifetime of the chip, no matter for what applications. (A random number is a section of this bit sequence.) If e.g. in one application a random byte is required, then (the next) eight output bits of the pseudo random number generator are used and combined to one byte.

When the chip is turned off, i.e. is not in operation, then also the pseudo random number generator is at rest. Shortly before the chip is turned off, however, the last produced section of the output sequence of the pseudo random number generator (of the length of the original seed) is written into the NVM. When the chip is newly started, the pseudo random number generator is initialized with exactly this “new seed” from the NVM. Thus, the pseudo random number generator continues its operation preferably exactly at the location where it stopped before the turn-off.

A physical RNG (in the analog part) is therefore replaced by a purely digital RNG. This is a high-performance, low-cost pseudo random number generator implemented in hardware. The initialization of the pseudo random number generator is performed within the personalizing of the chip in the factory. Hereby, on the basis of a physical random process, a chip-individual real-random seed is generated and written into the NVM of the chip.

As it has already been implemented, in the factory in a secure environment a true random bit sequence is generated, i.e. by a physical random process that may include a radioactive decomposition, a voltage-controlled oscillator, etc. This true bit sequence is then the seed. This seed is then preferably written into the EEPROM of the chip card and using the seed the pseudo random number generator is initialized on the card. The random bits produced in the sequence are then used for all chip card applications. It is preferred for cryptographic purposes that the seed and thus the random number is secret or only known to the user of the chip card, respectively, as the user of the chip card will use a random number for example for an RSA key generation. If someone was able to be determine the seed from the card he might also determine any random numbers generated by the inventive random number generator by copying the random number generator itself and then feeding in the seed. Thus, in extremely secure applications, including financial transactions, access identifications, etc., it is preferred that the user of the chip card somehow encrypts the seed with an identification information (pin) that is only known to himself before he starts his random number generator with the same. It is to be noted, that in this case a decryption of the encrypted seed is not required, as the encrypted seed is used as an initial value or initialization value, respectively, for the pseudo random number generator. By this it is guaranteed that the user is also independent of the manufacturer of the chip card, i.e. for the case in which the manufacturer of the chip card would—without authorization—store and later output the initialization information with which the card was originally initialized in the factory.

It is also advantageous that an attacker may not get the seed stored in the NVM out of the card somehow when the chip card is currently not in operation. Therefore, it is preferred not only to store the state of the pseudo random number generator before turning off the same but to encrypt it before storing so that the data stored in the memory are worthless for an attacker, except if he could “crack” the encryption which is connected with a very high expense if not impossible.

In this case the user of the chip card would then first of all decrypt the intermediate state which is stored in an encrypted way when a renewed start-up of the random number generator is desired, in order to then initialize the random number generator with the decryption result so that it is guaranteed that the user stays within the same sequence, which is rooted in the originally generated random number in the factory or the random number encrypted by the user.

While typically in the prior art all three steps for generating true random numbers take place on the chip card itself, i.e. the physical random process, the digitizing of the analog data and the mathematical post-processing of the digitized analog data, in order to obtain the statistical characteristics that are required, in the inventive method the two first steps, i.e. the random process and the digitizing of the analog data already take place in the factory, and in the chip itself only so-to-speak the mathematical post-processing takes place, i.e. by a good pseudo random number generator which is implemented in hardware.

This concept is advantageous in so far that there are no problems with analog elements. Further, the present invention provides a high-speed generation of the random bit sequence with a guaranteed constant quality of the produced random numbers. Further, the inventive concept may not be influenced from the outside by temperature fluctuations, radiation or other physical influences, like a physical random process. Further, the inventive concept distinguishes itself by a good convertibility into a new technology (shrinking). Further, an area-saving with a factor of about 10 is achieved, as analog elements use a considerable amount of area compared to a shift register element, although it may be quite voluminous, representing the pseudo random number generator. As for the pseudo random number generator any current-saving digital technologies may be used, the inventive random number generator also distinguishes itself by a low current consumption. Finally, the inventive concept also allows reducing the run-up time to the ATR (ATR=answer to reset) compared to a chip with an analog random number generator. Depending on the conditions, the inventive method may be implemented in hardware or in software. The implementation may be performed on a digital storage medium, in particular on a floppy disc or a CD with electronically readable control signals which may thus cooperate with a programmable computer system so that the corresponding method is performed. In general, the invention thus also consists in a computer program product with a program code for performing the inventive method stored on a machine-readable carrier when the computer program product runs on a computer. In other words, the invention may thus be realized as a computer program with a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A device for generating random numbers, comprising:
a pseudo random number generator implemented in order to generate a deterministic random number sequence after an initialization using an initialization value; and
a memory for storing initialization information, wherein the initialization information is derived from a true random number or corresponds to the true random number; and
a sequential controller which is implemented
in order to initialize the pseudo random number generator at start-up using the initialization information or the information derived from the initialization information,
in order to store an intermediate state of the pseudo random number generator or information derived from the intermediate state in the memory at a turn-off of the pseudo random number generator, and
in order to use the intermediate state or the information derived from the intermediate state for an initialization of the pseudo random number generator at a renewed start-up.

2. The device according to claim 1, wherein the pseudo random number generator includes one or several feedback shift registers with a number of register cells, and wherein the initialization value is binary and comprises a number of digits equal to the number of register cells.

3. The device according to claim 1, wherein the pseudo random number generator is completely set up of digital elements.

4. The device according to claim 1, wherein the memory is a writable non-volatile memory.

5. The device according to claim 1, further comprising:
deriver for deriving the initialization information from an original value, wherein the deriver is implemented in order to derive the initialization information using user identification information from the true random number.

6. The device according to claim 1, wherein the true random number is a number which was generated by a physical random number generator.

7. The device according to claim 1,
wherein the sequential controller is implemented to rewrite a value stored in the memory during a turn-off of the pseudo random number generator by an intermediate state or the information derived from the intermediate state.

8. The device according to claim 1, wherein the sequential controller is implemented
in order to first encrypt the initialization information or the information derived from the initialization information and then store the same into the memory,
in order to first decrypt the initialization information and then provide the same to the pseudo random number generator,
in order to encrypt the intermediate state before storing and then store an encryption result, and
in order to decrypt the stored encryption result at a renewed start-up and use the decryption result for a renewed initialization of the pseudo random number generator.

9. The device according to claim 1,
wherein the sequential controller is implemented in order to determine a last defined state of the pseudo random number generator as an intermediate state in a turn-off of the pseudo random number generator.

10. The device according to claim 1,
wherein the pseudo random number generator is implemented in order to generate a deterministic random number sequence so that the same has a period length which is greater than 2⁶⁴.

11. The device according to claim 1,
wherein the pseudo random number generator comprises a plurality of non-linear feedback shift registers respectively generating an output sequence, and wherein the pseudo random number generator further comprises a combiner which is implemented in order to combine the output sequences of the individual non-linear feedback shift registers in order to generate the random number sequence.

12. The device according to claim 1, wherein the pseudo random number generator further comprises:
a provider for providing a number of 2 n number sequences, wherein n is greater than or equal to 2; and
a combiner for combining the number sequences in order to obtain an output sequence, wherein the combiner comprises:
an intermediate processing stage for combining the number sequences in order to generate an intermediate processing sequence; and
a final processing stage for combining a subgroup of k of the number sequences with the intermediate processing sequence, in order to obtain the output sequence, wherein k is greater than or equal to 1 and smaller than n.

13. The device according to claim 12, wherein the final processing stage includes an adder.

14. The device according to claim 13, wherein the number sequences are binary sequences and the adder is implemented as an XOR gate.

15. The device according to claim 12, wherein the intermediate processing stage comprises:
a first combiner for combining a first group of n number sequences in order to obtain a first group number sequence;
a second combiner for combining a second group of n number sequences in order to obtain a second group number sequence; and
a third combiner in order to combine the first group number sequence and the second group number sequence in order to obtain the intermediate processing sequence.

16. The device according to claim 15, wherein the first intermediate processor and the second intermediate processor use the same combination specification, wherein this combination specification is different from a combination specification which is to be performed by the third combiner.

17. The device according to claim 15, wherein the first combiner comprises an adder, the second combiner comprises an adder, and the third combiner comprises a multiplier.

18. The device according to claim 17, wherein the number sequences are binary sequences, the first combiner (120a) comprises an XOR gate, the second combiner (120b) comprises an XOR gate and the third combiner (124) comprises an AND gate.

19. The device according to claim 12,
wherein the intermediate processing stage comprises exactly one adder for adding n number sequences, exactly one adder for adding n residual number sequences and exactly one multiplier for multiplying results of the first and the second adder, and
wherein the final processing stage comprises exactly one adder for adding the intermediate processing sequence with a first subgroup of k number sequences and a second subgroup of k other number sequences.

20. The device according to claim 11,
wherein a provider for providing comprises an individual feedback elementary shift register for each number sequence.

21. The device according to claim 20, wherein at least one of the feedback elementary shift registers is a shift register with a non-linear feedback characteristic.

22. The device according to claim 12, wherein an elementary shift register comprises:
a plurality of memory cells connected in series,
wherein the elementary shift register output is coupled to an output of a memory cell,
a feedback with a feedback input and a feedback output, wherein the feedback input is connected to an output of a memory cell, and
wherein the feedback is implemented in order to combine signals at the outputs of at least two memory cells to each other in a non-linear way.

23. The device according to claim 20,
wherein each feedback shift register comprises a number of memory cells, wherein the number of memory cells of the elementary registers are different from each other.

24. The device according to claim 20, wherein each feedback shift register comprises a number of memory cells, and wherein the numbers of memory cells of the shift registers are prime to each other in pairs.

25. The device according to claim 20, wherein each feedback shift register comprises a number of memory cells, and wherein the elementary shift registers are implemented so that a greatest common divisor between the numbers of the memory cells is equal to 1 among all shift registers.

26. The device according to claim 12, wherein a provider for providing is implemented in order to generate the 2 n number sequences so that the same are maximum-periodic.

27. The device according to claim 12, wherein a provider for providing is implemented in order to generate the 2 n number sequences so that they have a linear complexity which is equal to the maximum linear complexity or at most smaller by a predetermined amount than the maximum linear complexity.

28. The device according to claim 27, wherein the predetermined amount is at 75% of the maximum linear complexity.

29. The device according to claim 12, wherein a combiner for combining is implemented in order to only include gates selected from the group consisting of AND gates, NAND gates, OR gates, NOR gates, XOR gates, and XNOR gates.

30. A chip card having a device for generating random numbers, comprising:
a pseudo random number generator implemented in order to generate a deterministic random number sequence after an initialization using an initialization value;
a memory for storing initialization information, wherein the initialization information is derived from a true random number or corresponds to the true random number; and
a sequential controller which is implemented
in order to initialize the pseudo random number generator at the start-up using the initialization information or the information derived from the initialization information,
in order to store an intermediate state of the pseudo random number generator or information derived from the intermediate state in the memory at a turn-off of the pseudo random number generator, and
in order to use the intermediate state or the information derived from the intermediate state for an initialization of the pseudo random number generator at a renewed start-up.

31. A method for generating random numbers using a pseudo random number generator which is implemented in order to generate a deterministic random number sequence based on an initialization value, a memory for storing initialization information, wherein the initialization information is derived from a true random number or corresponds to the true random number, the method comprising the steps of:
in a start-up of the pseudo random number generator, initializing the pseudo random number generator with the initialization information or the information derived from the initialization information;
outputting random numbers of the initialized pseudo random number generator;
in a turn-off of the pseudo random number generator, storing an intermediate state of the pseudo random number generator or of a value derived from the intermediate state of the pseudo random number generator into the memory; and
in a renewed start-up of the pseudo random number generator, using the stored intermediate state or the information derived from the intermediate state for a renewed initialization of the pseudo random number generator.

32. A method for manufacturing a random number generator, comprising the steps of:
providing a pseudo random number generator which is implemented in order to generate a deterministic random number sequence based on an initialization value, a memory for storing initialization information, wherein the initialization information is derived from a true random number or corresponds to the true random number, and a sequential controller;
providing a random number; and
storing the random number or information derived from the random number in the memory as initialization information.

33. A method for personalizing a random number generator with a pseudo random number generator, a memory and a sequential controller, wherein in the memory a true random number or information derived from the true random number is stored, the method comprising the steps of:
encrypting the true random number or the information derived from the true random number with personalization identification information in order to obtain an encrypted random number; and
storing the encrypted random number in the memory so that in a start-up of the random number generator the encrypted random number stored in the memory may be used for an initialization of the pseudo random number generator.

34. A computer program having a program code for performing a method for generating random numbers using a pseudo random number generator which is implemented in order to generate a deterministic random number sequence based on an initialization value, a memory for storing initialization information, wherein the initialization information is derived from a true random number or corresponds to the true random number, the method comprising the steps of:
in a start-up of a pseudo random number generator, initializing the pseudo random number generator with the initialization information or the information derived from the initialization information;
outputting random numbers of the initialized pseudo random number generator;
in a turn-off of the pseudo random number generator, storing an intermediate state of the pseudo random number generator or of a value derived from the intermediate state of the pseudo random number generator into the memory; and
in a renewed start-up of the pseudo random number generator, using the stored intermediate state or the information derived from the intermediate state for a renewed initialization of the pseudo random number generator,
when the method runs on a computer.

35. A computer program having a program code for performing a method for manufacturing a random number generator, the method comprising the steps of:
providing a pseudo random number generator which is implemented in order to generate a deterministic random number sequence based on an initialization value, a memory for storing initialization information, wherein the initialization information is derived from a true random number or corresponds to the true random number, and a sequential controller;
providing a random number; and
storing the random number or the information derived from the random number in the memory as initialization information,
when the method runs on a computer.

36. A computer program having a program code for performing a method for personalizing a random number generator with a pseudo random number generator, a memory and a sequential controller, wherein in the memory a true random number or information derived from the true random number is stored, the method comprising the steps of:
encrypting the true random number or the information derived from the true random number with personalization identification information in order to obtain an encrypted random number; and
storing the encrypted random number in the memory so that in a start-up of the random number generator the encrypted random number stored in the memory may be used for an initialization of the pseudo random number generator;
when the method runs on a computer.
